(19) United States
(12) Patent Application Publication
(10) Pub. No.: US 2008/0091959 A1
(43) Pub. Date: Apr. 17, 2008

(54) Auto management for power system

(75) Inventors: Cheng-Ping Yu, Chung Ho City (TW); Hung-Chi Lin, Chung Ho City (TW)

Correspondence Address: EVALUE TECHNOLOGY INC., P.O. BOX 108-00403, TAIPEI (R.O.C.), omitted

(73) Assignee: EVALUE TECHNOLOGY INC., Chung Ho City (TW)

(21) Appl. No.: 11/549,114

(22) Filed: Oct. 12, 2006

(51) Int. Cl. G06F 1/00

(52) U.S. Cl. 713/300

(57) ABSTRACT

An auto management for a power system is disclosed. The power system disposed on a motherboard. The motherboard comprises a microcomputer controller, a first low power consumption module and a second low power consumption module. The microcomputer controller disposed on the motherboard is adopted for outputting a power control signal to the first low power consumption module or the second low power consumption module and inputting the power control signal to a main system from the first low power consumption module or a sub-system from the second low power consumption module when the microcomputer controller senses a signal of an external power supply.

### BACKGROUND OF THE INVENTION

1. Field of the invention

The present invention relates to an auto management for a power system, and more particularly to a management method using a microcomputer controller to manage automatically for operating such that the stability of the power system is promoted, and the number of components and the power cords in the power system may be reduced and thereby reduce the space occupation as well as the manufacturing cost.

2. Description of Related Art

The change of time has created innovation and revolution of several products, and accordingly more and more products are designed according to the consumers' need. The consumers nowadays demand for better quality, and that's why the market has become more and more competitive as well. For surviving in today's tough competition, it is necessary to develop new products that meet the consumers' need.

For example, the electronic products are being developed all the time, and the purpose of the development is mostly for increasing the efficiency of the electronic products, reducing the cost, and also to minimize the size of the electronic products. However, most of the electronic products are designed to be lighter, thinner, shorter and smaller, except for the personal computer (PC) due to the power supply. Although the PC has other problems that needed to be improved, for example the heat dissipation problem, and therefore the manufacturers in the field should work on finding a way to overcome the defects.

Furthermore, the present inventor has noted that the 3½″ micro modules in the product is required to meet the specification of the Intel ATX (advanced technology expanding) and needs several cords to support this. Thus, this would occupy a larger space. Besides, the micro module is unstable due to the power noise and the power supply of various manufacturers.

For effectively executing the power specification, for example the difference between the AT and ATX is in the connector and the output voltage. The ATX has a connector with 20 pins to connect to the motherboard, and the AT has 6 pins and only the pin 8 (P8) and pin 9 are adopted for connecting to the motherboard. Furthermore, the ATX has two output voltages, +3.3 V, 5 Vsb, however the AT doesn't have these two output voltage. Accordingly, the products have the following defects.

1. Several cords are needed to support execution of the power specification. Accordingly, related electronic components are essential. Thus, the manufacturing cost is increased and the motherboard layout has limited space.

2. Single power supply cannot be used to simulate the power specification of the ATX, and it's not compatible with all the power supply and chips of the AT/ATX.

3. The cold boot problem exist, and the user has to completely turn off the power and then turn on again for subsequent operation;

4. The power noise cannot be reduced, thus the errors may easily occur.

The micro module has to be as thin, light, short and small as possible and free from the limitation of specification of Intel ATX. Therefore, how to manage the 3½″ micro modules products is an important issue for the manufacturers in the field.

### SUMMARY OF THE INVENTION

According to an aspect of the present invention, the microcomputer controller is adopted for automatically managing the power for turning on/off the device when the microcomputer controller receives an external power supply. The power management according to the present invention has at least the following advantages.

1. The space occupation of the cord of the power system can be reduced, and accordingly the cost of the related electronic components can be effectively reduced and correspondingly, the space utilization for the layout on the motherboard can be increased.

2. The present invention is suitable for single set power supply to simulate the specification of the ATX power supply, and the present invention is compatible with all the AT/ATX power supply.

3. The power need not be completely shut down and for restarting the power supply again. In other words, there is no cold boot problem.

4. The power noise can be effectively resisted to avoid the error.

5. The chips manufactured by various manufacturers can be accommodated by executing power specification.

6. The present invention is compatible with the specification, such as S0˜S5, a new power supply management ACPI (advanced configuration & power interface), and it supports the function of storing the execution information into the memory (STR) to suspend the disk (STD) while turning off the device.

7. The LED is adopted for indicating the status of the power system.

### BRIEF DESCRIPTION OF THE DRAWING

FIG. 1 is a block diagram of a power system according to an embodiment of the present invention.

FIG. 2 is a flow chart of an operation procedure of a microcomputer controller of the power system according to an embodiment of the present invention.

### DETAIL DESCRIPTION OF THE INVENTION

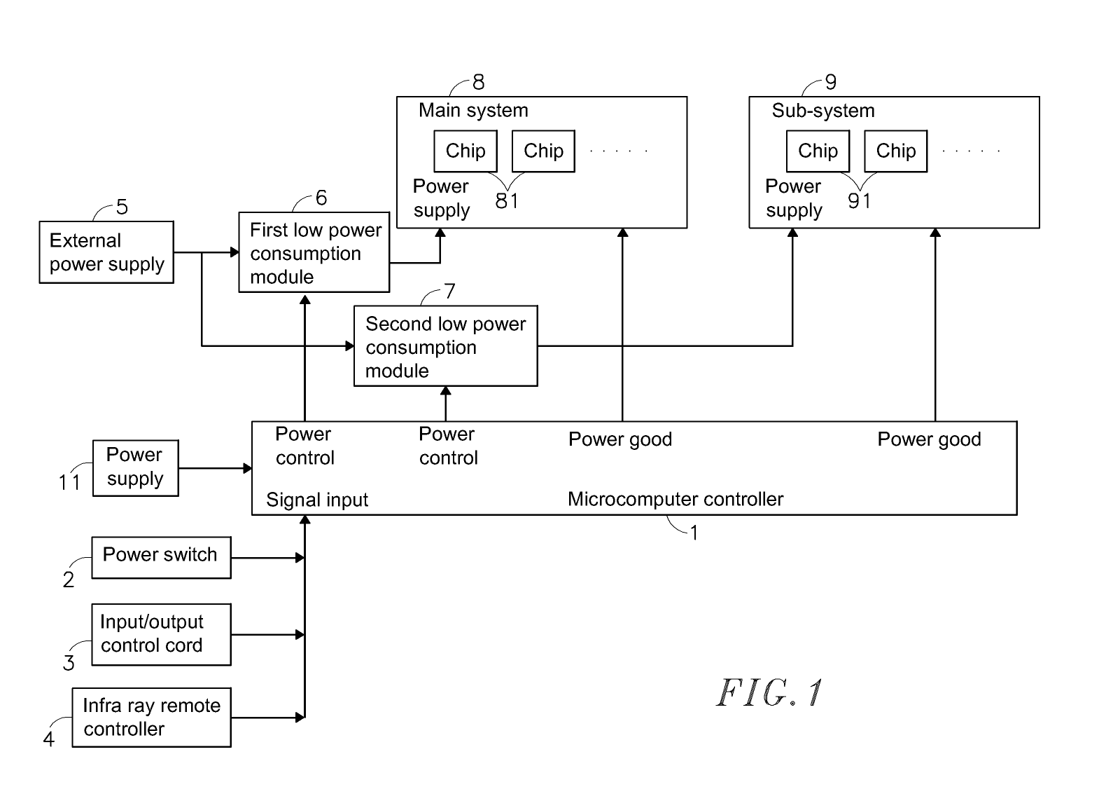

Referring to FIG. 1, a power system on a motherboard of the present invention comprises a microcomputer controller 1. The microcomputer controller 1 can operate with a power supply 11 and can receive a signal input from a power switch 2, a input/output control cord 3 or an infra ray remote controller 4. When the microcomputer controller 1 senses a signal input from an external power supply (a single power) 5 to a first low power consumption modules 6 or a second low power consumption modules 7 on the motherboard, the microcomputer controller 1 outputs a power control signal to the first low power consumption module 6 or the second low power consumption modules 7, and then the first low power consumption modules 6 further inputs the power control signal to a main system 8, or the second low power consumption modules 7 further inputs the power control signal to the sub-system 9. The microcomputer controller 1 can also control a power good of the main system 8 or the sub-system 9 to effectively execute the power specification (for example, the AT or ATX).

In the present invention, the main system 8 and the sub-system 9 respectively have chip set 81 and 91. The first low power consumption module 6 controls the power supply of, for example, the CPU; and the second low power consumption module 7 controls the power supply of, for example, the north and south bridge modules.

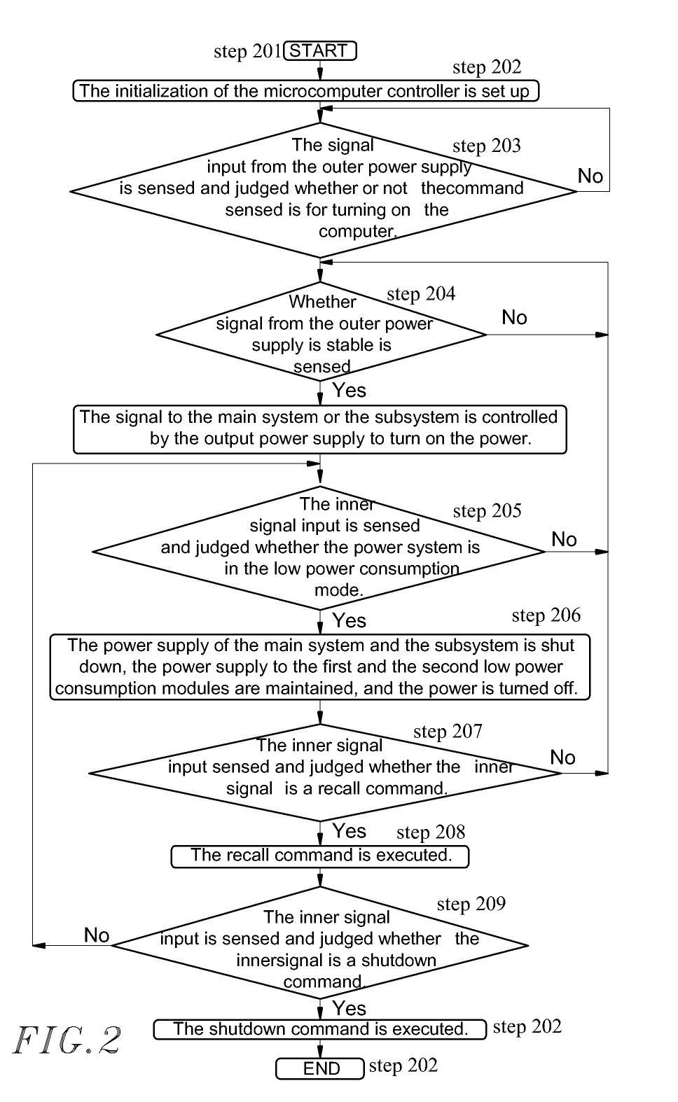

Referring to FIG. 2, the operation procedure of the microcomputer controller 1 may be described as follows.

At step 201, the operation procedure is started.

At step 202, the initialization of the microcomputer controller 1 is set up.

At step 203, a signal input from the external power supply 5 is sensed and judged whether or not the signal is a command for turning on the computer, wherein if it is judged that the command is not for turning on the computer, the procedure remain in step 203 and continues to sense, and if it is judged that the command is for turning on the computer, the procedure proceeds to step 204.

At step 204, the signal from the external power supply 5 is sensed and judge whether or not the signal is stable, wherein if it is judged that the signal is not stable, the procedure remain in step 204 and continues to sense, and if is judged that the signal is stable, the procedure proceeds to 205.

At step 205, a power control signal is outputted to the main system 8 or the sub-system 9 for operating.

At step 206, an inner signal input is sensed and judged whether the inner signal is a command of the low power consumption mode, wherein if it is judged that the command is the low power consumption mode, the procedure proceeds to step 207, otherwise the procedure goes to step 204.

At step 207, the power supply of the main system 8 and the sub-system 9 is shut down, the first and the second low power consumption modules 6 and 7 are maintained, and the power good of the main system 8 and the sub-system 9 is turned off.

At step 208, an inner signal is sensed and judged whether the inner signal is a recall command, wherein if it judged that the inner signal is the recall command, the procedure proceeds to the step 209, otherwise the procedure returns to step 204.

At step 209, the recall command is executed.

At step 210, an inner signal is sensed and judged whether the inner signal is a shutdown command, wherein if it is judged that the inner signal is the shutdown command, the procedure proceeds to step 211, otherwise the procedure returns to step 206.

At step 211, the shutdown command is executed.

At step 212, the procedure is ended.

Accordingly, only the microcomputer 1 is required to effectively execute the power specification through software without requiring the use of several cords. At the same time, a LED may be installed to indicate the status of the power system. Thus, the space occupation by the cords of the power system may be effectively reduced and because the number of electronic components can be reduced, the manufacturing cost can be reduced. Correspondingly, the space for the motherboard layout can be increased. The management method of the present invention is suitable for a single set power supply to simulate the specification of the ATX power supply, and the present invention is compatible with all the AT/ATX power supply, and therefore, there is no cold boot problem. Furthermore, the management method of the present invention can effectively resist the power noise to prevent error from occurring. The software executes power management function, and is suitable for all types of chips manufactured by various manufacturers. The management method of the present invention is also completely compatible with S0 to S5 standard in the ACPI (advanced configuration & power interface. The management method of the present invention also supports the function of storing the execution information into the memory (STR) to suspend to the disk (STD) while turning off the device.

Furthermore, the management method in the present invention can be applied in the IPC (industrial personal computer).

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A power system for a motherboard, comprising:
a first low power consumption module, disposed on said motherboard;
a second low power consumption module, disposed on said motherboard; and
a microcomputer controller, disposed on said motherboard, wherein when said microcomputer controller senses a signal output from an external power supply to said first low power consumption module or said second low power consumption module, said microcomputer controller outputs a power control signal to a main system from said first low power consumption module or a sub-system from said second low power consumption module, then said microcomputer controller can control a power good of said main system or said sub-system.

2. The power system according to claim 1, wherein said microcomputer controller respectively receives a signal input from a power switch, an input/output control cord or an infra-red ray remote controller.

3. An auto management for a power system, comprising:
setting up an initialization of a microcomputer controller;
sensing a signal input from an external power supply as a command for turning on power and being stable, and outputting a power control signal to a main system or a sub-system to operate;
sensing an inner signal as a low power consumption mode, shutting down a power supply to said main system and said sub-system, retaining a power supply to a first and second low power consumption modules, and turning off a power good of said main system and said sub-system; and
sensing a inner signal as a recall command and executing said recall command.

4. The auto management for a power system according to claim 2, wherein when sensing said inner signal is a shutting down command, said microcomputer controller executes said shutting down command.

5. The auto management for a power system according to claim 2, wherein said first low power consumption module controls a power supply for a CPU.

6. The auto management for a power system according to claim 2, wherein said second low power consumption module controls a power supply for a north and south bridge module.

7. The auto management for a power system according to claim 2, wherein said management method can apply in industrial personal computer.
